(19) United States
(12) Patent Application Publication
(10) Pub. No.: US 2023/0003239 A1
(43) Pub. Date: Jan. 5, 2023

(54) FASTENERS FOR HOUSING PANELS

(71) Applicant: HEWLETT-PACKARD DEVELOPMENT COMPANY, L.P., Spring, TX (US)

(72) Inventor: Tien Liang Chung, Taipei City (TW)

(21) Appl. No.: 17/305,163

(22) Filed: Jul. 1, 2021

(51) Int. Cl. F16B 2/22; F16B 5/06; H04M 1/02

(52) U.S. Cl. CPC F16B 2/22; F16B 5/065; F16B 5/0664; H04M 1/0252

(57) ABSTRACT

In some examples, a housing for an electronic device includes a first housing panel having a plurality of spring-loaded clips, a second housing panel having a plurality of pockets to receive the plurality of spring-loaded clips, and a first fastener on the first housing panel to slidingly engage a second fastener on the second housing panel after the plurality of spring-loaded clips are received in the plurality of pockets.

### BACKGROUND

An electronic device can include a housing that defines an inner chamber in which various electronic components can be contained. The housing can include multiple housing panels that are fastened together.

### BRIEF DESCRIPTION OF THE DRAWINGS

Some implementations of the present disclosure are described with respect to the following figures.

FIG. 1 is a schematic perspective view of housing panels that can be fastened together to form a housing for an electronic device, in accordance with some examples.

FIGS. 2A and 2B are front and rear perspective views of a spring-loaded clip according to some examples.

FIGS. 3A and 3B show mounting of a spring-loaded clip into a clip mount on a housing panel, in accordance with some examples.

FIGS. 4A and 4B show a housing panel with and without, respectively, spring-loaded clips mounted, in accordance with some examples.

FIG. 5 is a perspective view of a housing panel including pockets to receive spring-loaded clips on another housing panel, in accordance with some examples.

FIGS. 6A and 6B are sectional views of different portions of the housing panel of FIG. 5, according to some examples.

FIGS. 7A-7B and 8A-8B are sectional views of portions of housing panels attached together by a spring-loaded clip received in a pocket, in accordance with some examples.

FIG. 9 is a schematic perspective view of an electronic device according to some examples.

FIG. 10 is a flow diagram of a process of assembling a housing for an electronic device, in accordance with some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

When multiple housing panels of a housing for an electronic device are fastened together, inconsistent gaps or other visible artifacts may be present if a fastening mechanism used does not form a tight fit between the housing panels. An inconsistent gap between housing panels can refer to a gap that is wider in some sections than other sections of the gap. Other visible artifacts can include a portion of an edge of a housing panel being visible when it should not, warping of a portion of a housing panel, and so forth.

In accordance with some implementations of the present disclosure, an internal fastening mechanism is employed to tightly fasten housing panels of a housing of an electronic device. In some examples, the electronic device can include an electronic device containing an audio speaker, which is an output device to play audio. In other examples, the electronic device can be a different type of electronic device.

The internal fastening mechanism includes multiple spring-loaded clips provided on a first housing panel, which are able to engage respective pockets on a second housing panel. When the spring-loaded clips are inserted into the pockets of the second housing panel, the first and second housing panels can be shifted relative to one another against a biasing force of the spring-loaded clips to allow for alignment of further fasteners on the first and second housing panels. Once the further fasteners are aligned, the biasing force applied by the spring-loaded clips in the pockets can cause the fasteners to engage.

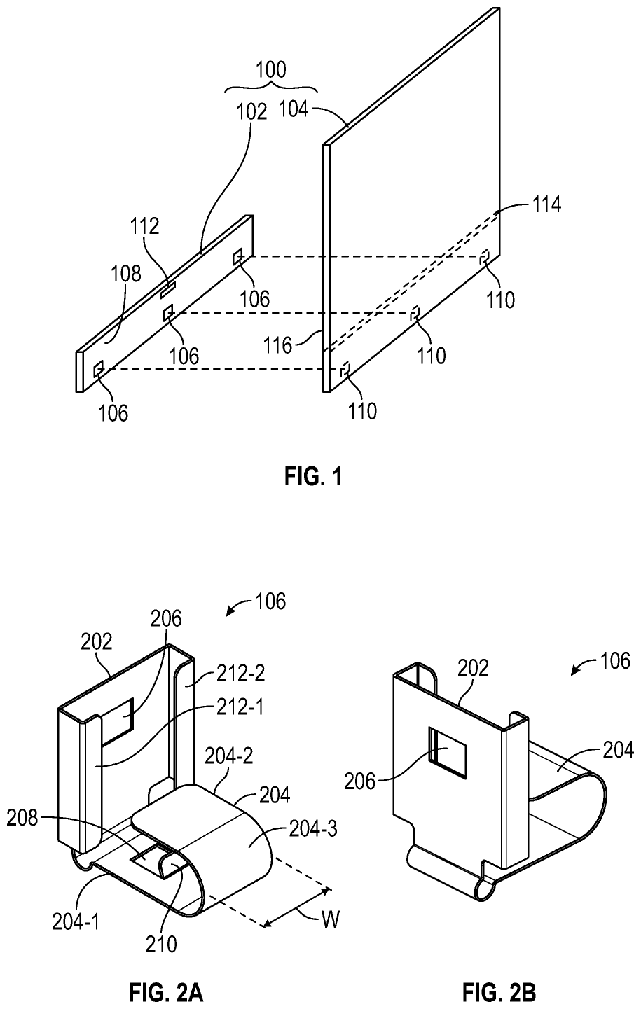

FIG. 1 is a schematic diagram of a housing 100 for an electronic device, according to some examples. The housing 100 includes a first housing panel 102 and a second housing panel 104 that are to be fastened together to define an inner chamber between the housing panels 102 and 104. The inner chamber can contain various electronic components of the electronic device. For example, the first housing panel 102 can be a speaker grill, which includes small openings (not shown in FIG. 1) through which audio can be output from an audio speaker contained in the inner chamber. The second housing panel 104 can include a back cover of the electronic device to which the speaker grill is to be fastened.

Although FIG. 1 shows an example in which the housing 100 includes two housing panels, it is noted that in other examples, the housing 100 can include more than two housing panels that are to be fastened together using fastening mechanisms according to some implementations of the present disclosure.

In some examples, an internal fastening mechanism is employed to fasten the first housing panel 102 to the second housing panel 104. An internal fastening mechanism can refer to a fastening mechanism that is not visible to a user from outside the housing 100 once the first and second housing panels 102 and 104 are fastened together.

The internal fastening mechanism includes multiple spring-loaded clips 106 that are attached to an inner surface 108 of the first housing panel 102. The inner surface 108 of the first housing panel 102 is the surface that faces the inner chamber of the housing 100 once the first and second housing panels 102 and 104 are fastened together.

A “spring-loaded clip” can refer to a fastener that is deformable and applies a biasing force in a given direction when deformed. The spring-loaded clip can have any of various different shapes, including those shown in various examples in the remaining figures.

The spring-loaded clips 106 can be initially separate from the first housing panel 102 and can be attached to the first housing panel 102. In other examples, the spring-loaded clips 106 can be integrally formed with the first housing panel 102.

The second housing panel 104 includes pockets 110 into which the spring-loaded clips 106 can be inserted. A “pocket” can refer to any opening that defines a receptacle to receive another structure, such as a portion of a corresponding spring-loaded clip 106.

In other examples, the spring-loaded clips 106 can be attached to the second housing panel 104, and the pockets 110 are provided in the first housing panel 102.

The first housing panel 102 further includes a first fastener 112 that is to slidingly engage a second fastener 114 on the second housing panel 104. The fasteners 112 and 114 are able to slidingly engage when one fastener 112 can slide relative to another fastener 114 from an initial un-fastened state to a fastened state. In the un-fastened state, the fasteners 112 and 114 are disengaged from one another. In the fastened state, the fasteners 112 and 114 are engaged physically together.

Although FIG. 1 shows just one fastener on the inner surface 108 of the first housing panel 102, in other examples, multiple fasteners 112 can be provided on the inner surface 108 of the first housing panel 102. The multiple fasteners 112 can engage with the second fastener 114 (or multiple second fasteners 114) on the second housing panel 104.

Also, FIG. 1 shows an example in which the fastener 114 of the second housing panel 104 is an elongated fastener. If there are multiple fasteners 112 on the first housing panel 102, these multiple fasteners 112 can engage with the elongated fastener 114. In other examples, the fastener 114 on the second housing panel 104 is a shorter fastener to engage a respective fastener 112 on the first housing panel 102. In such latter examples, there can be multiple discrete fasteners 114 on the second housing panel 104 to engage corresponding multiple fasteners 112 on the first housing panel 102.

The pockets 110 and the fastener 114 are arranged on an inner surface 116 of the second housing panel 104. The inner surface 116 of the second housing panel 104 faces the inner chamber when the first and second housing panels 102 and 104 are fastened together.

FIGS. 2A-2B show an example of the spring-loaded clip 106. FIG. 2A is a front perspective view of the spring-loaded clip 106, and FIG. 2B is a rear perspective view of the spring-loaded clip 106.

The spring-loaded clip 106 includes a backplate 202 and a generally U-shaped engagement prong 204. In other examples, the spring-loaded clip 106 can have a different configuration.

The engagement prong 204 has a first prong segment 204-1 that is integrally attached to a lower edge of the backplate 202, a second prong segment 204-2 that is spaced above the first prong segment 204-1 in the view of FIG. 2A, and a curved prong segment 204-3 that is integrally attached between the first and second prong segments 204-1 and 204-2. The curved prong segment 204-3 provides a curved engagement surface that is to be received in a corresponding pocket 110 of the second housing panel 104.

The backplate 202 includes a locking opening 206 that is to lock the spring-loaded clip to a feature of the first housing panel 102 to lockingly attach the spring-loaded clip 106 to the inner surface 108 of the first housing panel 102.

The first prong segment 204-1 further includes a retention opening 208 to receive a retaining protrusion (discussed further below) of a corresponding pocket 110. An engagement tab 210 rises from an upper surface of the first prong segment 204-1. The engagement tab 210 is positioned on one side of the retention opening 208. The engagement tab 210 has an engagement surface that is to engage a retention surface of a retention protrusion that is received through the opening 208 once the spring-loaded clip 106 is engaged in a corresponding pocket 110, as discussed further below.

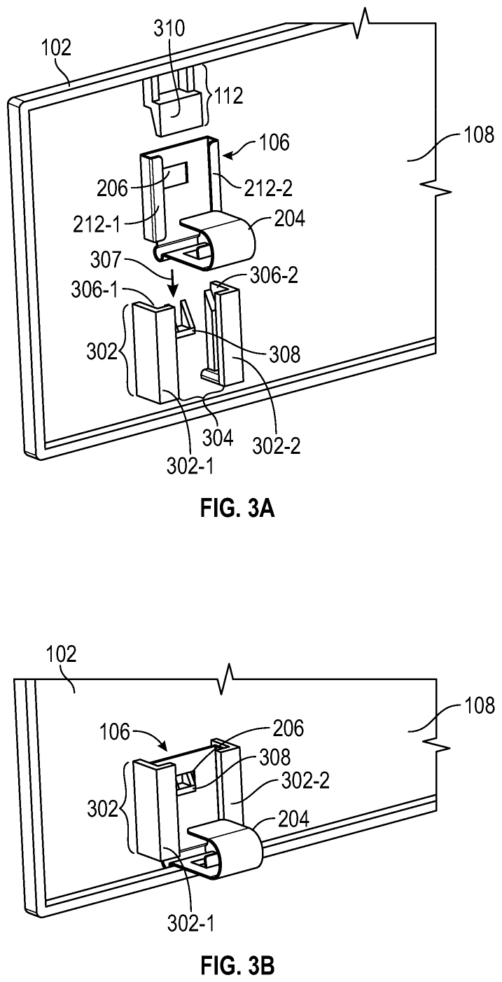

FIG. 3A further shows a clip mount 302 that is attached to the inner surface 108 of the first housing panel 102. The clip mount 302 has a first channel rail 302-1 and a second channel rail 302-2 on the left and right sides, respectively, of the clip mount 302 in the view of FIG. 3A. The channel rails 302-1 and 302-2 are spaced apart from one another by a gap 304. The gap 304 has a width that is sufficient to accommodate a width W (FIG. 2A) of the engagement prong 204 of the spring-loaded clip 106. The width of the gap 304 may be slightly larger than the width W of the engagement prong 204 so that the engagement prong 204 can slide into the gap 304 while maintaining a snug fit in the gap 304.

The first channel rail 302-1 defines a first channel 306-1, and the second channel rail 302-2 defines a second channel 306-2. The channels 306-1 and 306-2 are to receive corresponding engagement rails 212-1 and 212-2 that are integrally attached to the backplate 202 of the spring-loaded clip 106.

The spring-loaded clip 106 can be lowered in a direction 307 in the view of FIG. 3A into the clip mount 302, such that the engagement rails 212-1 and 212-2 are received by the corresponding channels 306-1 and 306-2 of the clip mount 302. Once the spring-loaded clip 106 is fully inserted into the clip mount 302, as shown in FIG. 3B, a locking tab 308 of the clip mount 302 protrudes into the locking opening 206 of the spring-loaded clip 106, to lockingly engage the spring-loaded clip 106 to the clip mount 302. The locking tab 308 once engaged in the locking opening 206 prevents the spring-loaded clip 106 from being inadvertently raised out of the clip mount 302.

More generally, each clip mount 302 has a locking surface to engage a locking feature of a corresponding spring-loaded clip 106 when the corresponding spring-loaded clip 106 is received in the respective clip mount 302.

FIG. 3A further shows the fastener 112 attached to the inner surface 108 of the first housing panel 102. In examples according to FIG. 3A, the fastener 112 includes a hook 310. In other examples, the fastener 112 can be a different type of fastener.

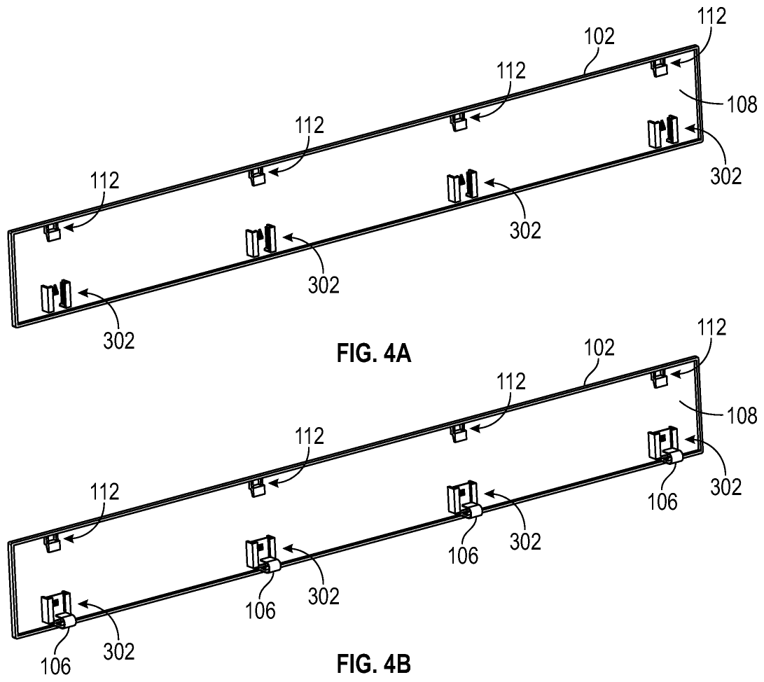

FIG. 4A is a perspective view of the first housing panel 102 when looking at the inner surface 108 of the first housing panel 102. In FIG. 4A, the spring-loaded clips 106 have not yet been inserted into the clip mounts 302.

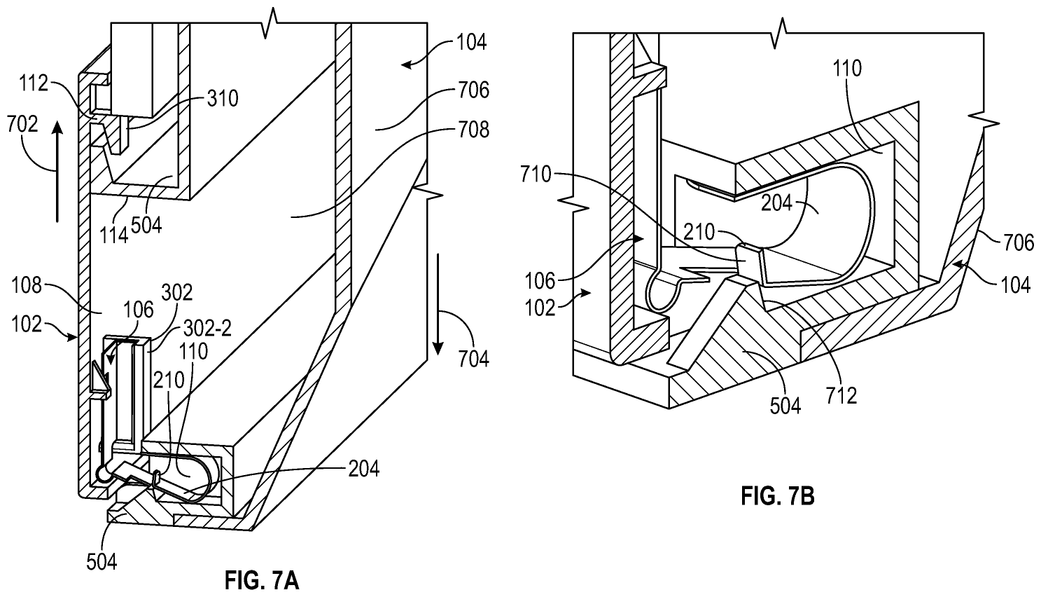

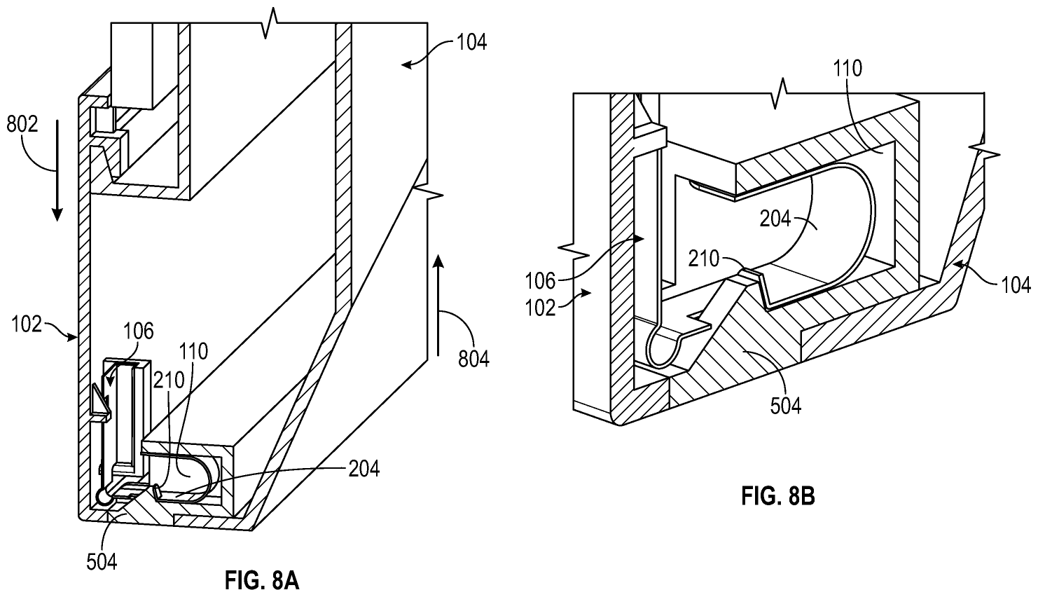

FIG. 4B is a perspective view of the inside of the first housing panel 102 with the spring-loaded clips 106 inserted into the respective clip mounts 302. When the spring-loaded clips 106 are received in the pockets 110, the first housing panel 102 is shiftable relative to the second housing panel 104 against a biasing force of the spring-loaded clips 106 to align the first fastener(s) 112 and the second fastener(s) 114 (discussed in further detail in connection with FIGS. 7A-7B and 8A-8B). After the alignment of the first fastener(s) 112 and the second fastener(s) 114, the spring-loaded clips 106 received in the pockets 110 are to apply the biasing force to slidingly engage the fastener(s) 112 and the second fastener(s) 114.

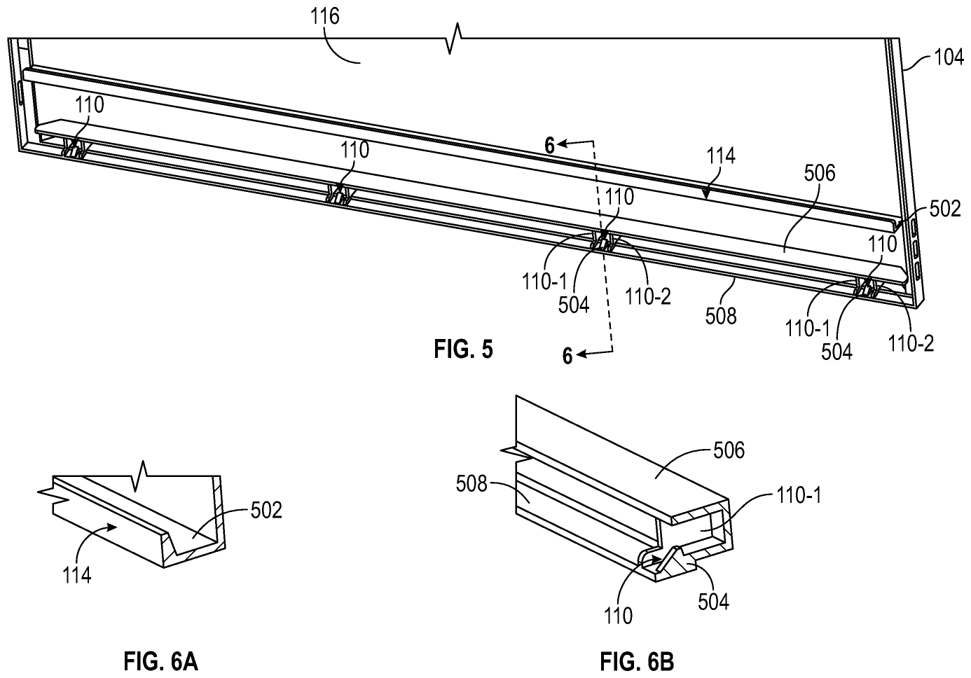

FIG. 5 is a perspective view of a portion of the inside of the second housing panel 104. The view of FIG. 5 faces the inner surface 116 of the second housing panel 104.

The pockets 110 provided on the inner surface 116 of the second housing panel 104 are to receive the spring-loaded clips 106.

The elongated fastener 114 is also provided on the inner surface 116 of the second housing panel 104. The elongated fastener 114 in some examples is a hook receiver that has a generally L-shaped structure that defines a groove 502 that slidingly receives the hooks 310 of the fasteners 112 depicted in FIG. 3A.

A sectional view along a section identified as 6-6 in FIG. 5 is depicted in FIGS. 6A-6B. FIG. 6A shows a portion of the elongated fastener 114 that has the groove 502.

FIG. 6B shows a portion of a pocket 110 (more specifically, half the pocket 110 is shown in the sectional view of FIG. 6B). Each pocket 110 has a left pocket wall 110-1 and a right pocket wall 110-2, that together define a receptacle for the engagement prong 204 of the spring-loaded clip 106.

Each pocket 110 further includes a retention protrusion 504 that is to protrude into a corresponding retention opening 208 of the corresponding spring-loaded clip 106 (FIG. 2A).

The second housing panel 104 further includes an elongated pocket cover 506 that extends across the width of the second housing panel 104 above the pockets 110. The elongated pocket cover 506 is located above the pockets 110. The second housing panel 104 further includes an elongated lower panel segment 508 that defines a floor of each of the pockets 110.

FIG. 7A is a perspective sectional view of portions of the first housing panel 102 and the second housing panel 104. In the sectional view of FIG. 7A, just half of a spring-loaded clip 106 and half of a pocket 110 are depicted. Also, just half of a clip mount 302 is depicted. In FIG. 7A, the engagement prong 204 of the spring-loaded clip 106 is received in the pocket 110.

To engage the fastener 112 and the fastener 114 after the spring-loaded clip 106 has been inserted into the pocket 110, a technician or other user may shift the first housing panel 102 in a generally upward direction 702, or shift the second housing panel 104 in a generally downward direction 704, or both, to position the hook 310 of the fastener 112 over the groove 502 of the fastener 114. The relative shifting of the first and second housing panels 102 and 104 as shown in FIG. 7A causes a deformation of each spring-loaded clip 106. The shifting of the first housing panel 102 relative to the second housing panel 104 in the direction 702 or 704 (or both) acts against a biasing force applied by the deformed engagement prong 204 of the spring-loaded clip 106.

FIG. 7B is an enlarged perspective view of portions of the first housing panel 102 and the second housing panel 104. In the views of FIGS. 7A-7B, the engagement prong 204 is deformed in an upward direction such that the engagement tab 210 of the spring-loaded clip 106 is positioned above the retention protrusion 504 of the pocket 110. In the position shown in FIG. 7B where the engagement tab 210 is above the retention protrusion 504, an engagement surface 710 of the engagement tab 210 is disengaged from a retention surface 712 of the retention protrusion 504. At this point, if desired, the technician or other user can remove the engagement prong 204 from the pocket 110.

The second housing panel 104 further includes a rear panel segment 706, which in combination with the first housing panel 102 defines an inner chamber 708 in which electronic components (e.g., a speaker or another electronic component) can be located.

As further shown in FIGS. 8A-8B, once the fasteners 112 and 114 have been brought into alignment as shown in FIG. 8A, the technician or other user can release a force that caused the relative shifting of the first housing panel 102 with respect to the second housing panel 104, and the biasing force applied by the engagement prong 204 can shift the first and second housing panels 102 and 104 relative to one another in opposite directions as shown in FIGS. 7A-7B. For example, the biasing force of the engagement prong 204 can cause the first housing panel 102 to be shifted generally downwardly 802, or the second housing panel 104 to be shifted generally upwardly 804, or both.

Additionally, the engagement prong 204 transitions from its deformed state shown in FIGS. 7A-7B to its original shape shown in FIGS. 8A-8B. The transition of the state of the engagement prong 204 from the deformed state to its original state causes the engagement tab 210 of the engagement prong 204 to mate with the retention protrusion 504 of the pocket 110. More specifically, the engagement surface 710 of the engagement tab 210 (FIG. 7B) is brought into physical contact with the retention surface 712 of the retention protrusion 504 of the pocket 110.

Once e engagement surface 710 of the engagement tab 210 is brought into physical contact with the retention surface 712 of the retention protrusion 504 of the pocket 110, the spring-loaded clip 106 is locked in the pocket 110, and cannot be pulled out of the pocket 110.

The retention surface 712 is sloped (e.g., it is not vertical but rather is angled with respect to the vertical) to allow for easier disengagement of the engagement surface 710 from the retention surface 712.

To disengage the spring-loaded clip 106 is locked in the pocket 110, a technician or other user can shift the first housing panel 102 in the direction 702 or the second housing panel 104 in the direction 704, or both, to cause deformation of the spring-loaded clip 106 such that the engagement tab 210 of the spring-loaded clip 106 is raised above the retention protrusion 504 of the pocket 110, which allows the technician or user to pull the spring-loaded clip 106 out of the pocket 110.

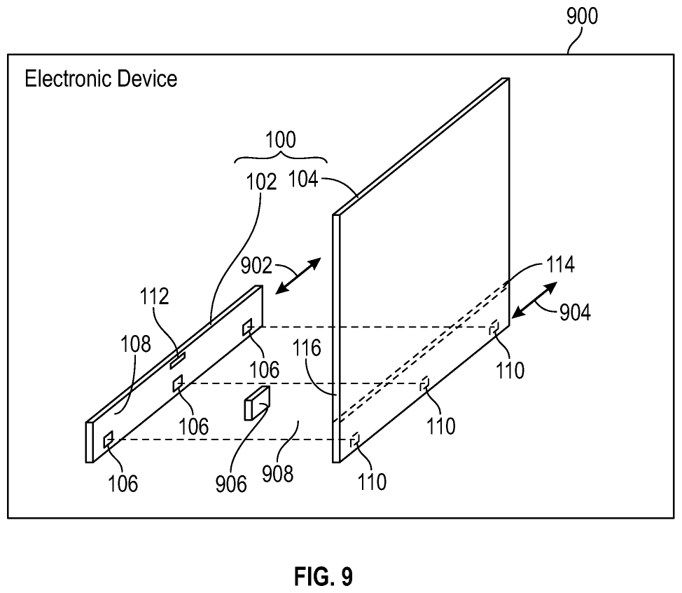

FIG. 9 is a diagram of an electronic device 900 that includes the elements depicted in FIG. 1, which share the same reference numerals. The spring-loaded clips 106 of the first housing panel 102 are arranged along a length axis 902 of the first housing panel 102.

The pockets 110 of the second housing panel 104 are similarly arranged along a length axis 904 of the second housing panel 104. The first fastener 112 on the first housing panel 102 slidingly engages the second fastener 114 on the second housing panel 104 after the spring-loaded clips 106 are received in the pockets 110.

The electronic device 900 includes an electronic component 906 located in an inner chamber 908 defined by the first housing panel 102 and the second housing panel 104 when attached together by the spring-loaded clips 106, the pockets 110, the first fastener 112, and the second fastener 114.

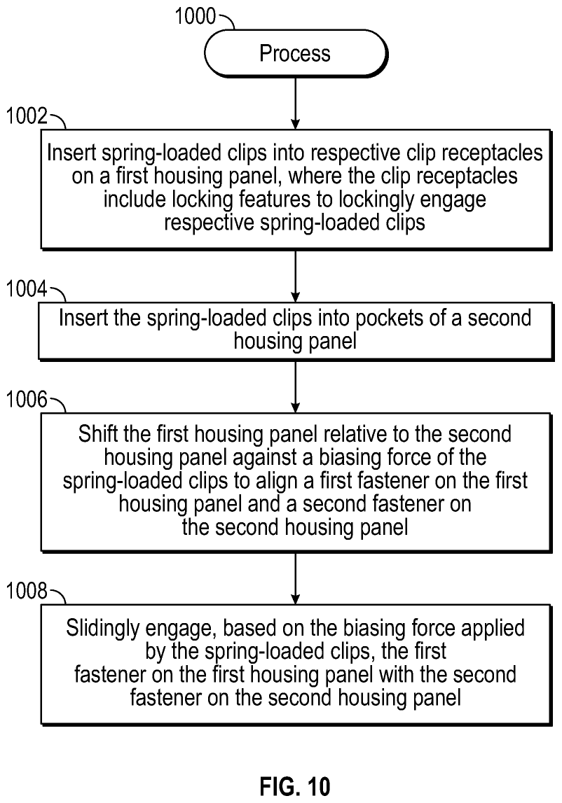

FIG. 10 is a flow diagram of a process 1000 of assembling a housing for an electronic device.

The process 1000 includes inserting (at 1002) spring-loaded clips (e.g., 106 in FIG. 1) into respective clip receptacles (e.g., the clip mounts 302 of FIGS. 3A-3B) on a first housing panel (e.g., 102). The clip receptacles include locking features (e.g., 308) to lockingly engage respective spring-loaded clips.

The process 1000 includes inserting (at 1004) the spring-loaded clips into pockets (e.g., 110) of a second housing panel (e.g., 104).

The process 1000 includes shifting (at 1006) the first housing panel relative to the second housing panel against a biasing force of the spring-loaded clips to align a first fastener (e.g., 112) on the first housing panel and a second fastener (e.g., 114) on the second housing panel.

The process 1000 includes slidingly engaging (at 1008), based on the biasing force applied by the spring-loaded clips, the first fastener on the first housing panel with the second fastener on the second housing panel.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A housing for an electronic device, comprising:
a first housing panel comprising a plurality of spring-loaded clips;
a second housing panel comprising a plurality of pockets to receive the plurality of spring-loaded clips; and
a first fastener on the first housing panel to slidingly engage a second fastener on the second housing panel after the plurality of spring-loaded clips are received in the plurality of pockets.

2. The housing of claim 1, wherein when the plurality of spring-loaded clips are received in the plurality of pockets, the first housing panel is shiftable relative to the second housing panel against a biasing force of the plurality of spring-loaded clips to align the first fastener and the second fastener.

3. The housing of claim 2, wherein after the alignment of the first fastener and the second fastener, the plurality of spring-loaded clips received in the plurality of pockets are to apply the biasing force to slidingly engage the first fastener and the second fastener.

4. The housing of claim 2, wherein one of the first fastener and the second fastener is a hook, and the other one of the first fastener and the second fastener is to slidingly receive the hook.

5. The housing of claim 1, wherein the first housing panel comprises clip mounts to receive respective spring-loaded clips of the plurality of spring-loaded clips.

6. The housing of claim 5, wherein each respective clip mount of the clip mounts has a locking surface to engage a locking feature of a corresponding spring-loaded clip of the plurality of spring-loaded clips when the corresponding spring-loaded clip is received in the respective clip mount.

7. The housing of claim 6, wherein the respective clip mount has a gap to slidingly receive the corresponding spring-loaded clip into the respective clip mount.

8. The housing of claim 1, wherein a first spring-loaded clip of the plurality of spring-loaded clips comprises an engagement surface, and a first pocket of the plurality of pockets has a retention surface to engage the engagement surface to retain the first spring-loaded clip in the first pocket.

9. The housing of claim 8, wherein the retention surface of the first pocket is sloped to allow disengagement of the engagement surface from the retention surface when the first housing panel is shifted relative to the second housing panel.

10. An electronic device comprising:
a first housing panel comprising a plurality of spring-loaded clips arranged along a length axis of the first housing panel;
a second housing panel comprising a plurality of pockets to receive the plurality of spring-loaded clips;
a first fastener on the first housing panel to slidingly engage a second fastener on the second housing panel after the plurality of spring-loaded clips are received in the plurality of pockets; and
an electronic component located in an inner chamber defined by the first housing panel and the second housing panel when attached together by the plurality of spring-loaded clips, the plurality of pockets, the first fastener, and the second fastener.

11. The electronic device of claim 10, wherein one of the first housing panel and the second housing panel comprises a speaker grill, and the electronic component comprises an audio speaker.

12. The electronic device of claim 10, wherein when the plurality of spring-loaded clips are received in the plurality of pockets, the first housing panel is shiftable relative to the second housing panel against a biasing force of the plurality of spring-loaded clips to align the first fastener and the second fastener, and wherein after the alignment of the first fastener and the second fastener, the plurality of spring-loaded clips received in the plurality of pockets are to apply the biasing force to slidingly engage the first fastener and the second fastener.

13. The electronic device of claim 10, wherein the first housing panel comprises clip mounts to receive respective spring-loaded clips of the plurality of spring-loaded clips, and wherein each respective clip mount of the clip mounts has a locking surface to engage a locking feature of a corresponding spring-loaded clip of the plurality of spring-loaded clips when the corresponding spring-loaded clip is received in the respective clip mount.

14. A method of assembling a housing for an electronic device, comprising:
inserting a plurality of spring-loaded clips into respective clip receptacles on a first housing panel, the clip receptacles comprising locking features to lockingly engage respective spring-loaded clips of the plurality of spring-loaded clips;
inserting the plurality of spring-loaded clips into pockets of a second housing panel;
shifting the first housing panel relative to the second housing panel against a biasing force of the plurality of spring-loaded clips to align a first fastener on the first housing panel and a second fastener on the second housing panel; and
slidingly engaging, based on the biasing force applied by the plurality of spring-loaded clips, the first fastener on the first housing panel with the second fastener on the second housing panel.

15. The method of claim 14, wherein the inserting of the plurality of spring-loaded clips into the pockets results in engagement of engagement surfaces of the plurality of spring-loaded clips with corresponding retention surfaces of the pockets.
